(19) United States
(12) Patent Application Publication
(10) Pub. No.: US 2015/0076238 A1
(43) Pub. Date: Mar. 19, 2015

(54) INTEGRATED LOOP STRUCTURE FOR RADIO FREQUENCY IDENTIFICATION

(71) Applicant: SMARTRAC IP B.V., Amsterdam (NL)

(72) Inventor: Tuomas Koskelainen, Pirkkala (FI)

(21) Appl. No.: 14/395,309

(22) PCT Filed: Apr. 11, 2013
(86) PCT No.: PCT/EP2013/057601

§ 371 Date: Oct. 17, 2014

Related U.S. Application Data
(60) Provisional application No. 61/635,326, filed on Apr. 19, 2012.

(51) Int. Cl. G06K 19/077

(52) U.S. Cl. CPC G06K 19/07783; G06K 19/07786
USPC 235/492

(57) ABSTRACT

An assembly for a radio frequency (RF) communication circuit includes an electrically insulating substrate having a first side and a second side. A first electrically conductive structure is arranged on the first side of the substrate. The first electrically conductive structure has the structure of a split loop that has a first end and a second end. The RF communication circuit is arranged to be attached to a site for the RF communication circuit between the first end and the second end. The assembly also includes a second electrically conductive structure arranged on the second side of the substrate. The second electrically conductive structure is arranged with respect to the first electrically conductive structure in such a manner that the site for the RF communication circuit overlaps the second electrically conductive structure in order to increase the capacitance of the assembly for the RF communication circuit.

### TECHNICAL FIELD

The present invention relates to inlays for Radio Frequency (RF) communication. In particular the invention relates to RF Identification (RFID) inlays and RFID tags that are used in packages, articles, or products having only limited space available for the RFID inlay.

### BACKGROUND OF THE INVENTION

RFID tags are small sized devices, typically in a label format, that can be applied to or incorporated into a product, device or even animal for the purpose of identification and tracking of the item in question using radio waves. Some RFID tags can be read from several meters away and beyond the line of sight of the reader. These capabilities make the use of RFID tags very interesting over optical bar codes in product logistics, even if the data contained in the RFID tags would be equal to the UPC (Universal Product Code), EAN (European Article Number) codes traditionally used in bar codes. EPC (Electronic Product Code) codes used globally in RFID tags make it possible to store more information in a standardized manner to the RFID tags than has been possible in case of basic optical bar codes. Thus, RFID tags are becoming increasingly popular in everyday product logistics in many commercial fields.

Typically RFID tags (or in some cases the RFID inlays) are attached to the articles or packages thereof. In case the article or package thereof is small in size, the RFID tag can take up a large portion of the article or package. Therefore, there is a need for smaller RFID tags.

### SUMMARY OF THE INVENTION

Despite of a wide variety of different existing RFID tag solutions there still is a clear need for a solution that would facilitate improved capability to tag small sized items and to utilize the full potential of RFID tags including the possibilities to use RFID. In order to improve the capability to tag small sized items, an assembly for a radio frequency (RF) communication circuits disclosed. In addition, a radio frequency transponder, comprising the assembly for the RF communication circuit is disclosed. Still further, an item comprising the radio frequency transponder is disclosed.

The assembly for a radio frequency (RF) communication circuit comprises,

an electrically insulating substrate having a first side and a second side,

a first electrically conductive structure arranged on the first side of the substrate, wherein

the first electrically conductive structure has the structure of a split loop, wherein the split loop structure comprises a first end and a second end, wherein the RF communication circuit is arranged to be attached to a site for the RF communication circuit between the first end and the second end such that the RF communication circuit closes the split loop, and

a second electrically conductive structure arranged on the second side of the substrate, wherein

the second electrically conductive structure is arranged with respect to the first electrically conductive structure in such a manner that the site for the RF communication circuit overlaps the second electrically conductive structure.

The second electrically conductive structure increases the capacitance of the assembly for the RF communication circuit.

These and other technical features are disclosed in the specification and the claims 1 to 24. The structure increases the capacitance of the joint between the RF communication circuit and the assembly for the RF communication circuit thereby decreasing operating frequency of the assembly, and, in effect, decreasing the size of the assembly.

### BRIEF DESCRIPTION OF THE DRAWINGS

In the following examples, the embodiments of the invention will be described in more detail with reference to the appended drawings, in which

FIG. 1a shows an assembly for a radio frequency (RF) communication circuit, as seen from top,

FIG. 1b shows the assembly of FIG. 1a for a radio frequency (RF) communication circuit, as seen from bottom,

FIG. 1c shows the assembly of FIG. 1a for a radio frequency (RF) communication circuit, in a perspective view,

FIG. 1d shows a RF transponder comprising the assembly of FIG. 1a and a circuit attached to the assembly, in a perspective view,

FIGS. 2a-2c shows examples of split loop structures,

FIG. 2d shows a circular split ring structure, the split ring structure being also a split loop structure,

FIGS. 2e1-2e3 show an example of a split ring structure on the first side of the substrate, a corresponding split ring structure on the second side of the substrate, and the two loop structures aligned,

FIGS. 2f1-2f3 show an example of a split loop structure on the first side of the substrate, a corresponding split loop structure on the second side of the substrate, and the two loop structures aligned,

FIGS. 2g1-2g3 show an example of a split loop structure on the first side of the substrate, a corresponding split loop structure on the second side of the substrate, and the two loop structures aligned,

FIG. 3a shows an assembly for a radio frequency (RF) communication circuit comprising two overlapping split ring structures as seen from top,

FIG. 3b shows an assembly for a radio frequency (RF) communication circuit comprising two overlapping split ring structures as seen from bottom,

FIG. 3c shows an assembly for a radio frequency (RF) communication circuit comprising two overlapping split ring structures, in a perspective view,

FIG. 4a shows two overlapping split ring structures of an assembly for a radio frequency (RF) communication circuit as seen from top,

FIG. 4b shows two overlapping split ring structures of an assembly for a radio frequency (RF) communication circuit as seen from top,

FIG. 5a shows an assembly for a radio frequency (RF) communication circuit, comprising two overlapping split ring structures as seen from top, the structure further comprising an antenna,

FIG. 5b shows an assembly for a radio frequency (RF) communication circuit, comprising two overlapping split ring structures as seen from top, the structure further comprising an antenna,

FIG. 5c shows an assembly for a radio frequency (RF) communication circuit, comprising two overlapping split ring structures as seen from top, the structure further comprising an antenna,

FIG. 6 shows an assembly for a radio frequency (RF) communication circuit, comprising multiple overlapping split loop structures as seen from top, the structure further comprising two mutually perpendicular dipole antennas,

FIG. 7a shows an assembly for a radio frequency (RF) communication circuit, comprising multiple co-centric overlapping split loop structures, in an exploded perspective view,

FIG. 7b shows an assembly for a radio frequency (RF) communication circuit, comprising multiple co-centric overlapping split loop structures, in an exploded perspective view, and

FIG. 7c shows an assembly for a radio frequency (RF) communication circuit, comprising multiple co-centric overlapping split loop structures, as seen from top, the figure also showing the ring structures of different layers.

### DETAILED DESCRIPTION OF THE INVENTION

An RFID tag typically comprises an RFID inlay and an overlay structure forming the RFID tag. The RFID inlay is an electrically fully functional RFID transponder device, that is, a device that works as a transmitter and responder. The main components of the transponder are an RF communication circuit (i.e. an electronic integrated circuit) and an antenna. An inlay further comprises a substrate and other optional layers to support the transponder. The overlay structure of an RFID tag forms further mechanical support for the inlay and it can be used for printing trademarks, brand names etc. Overlays can be e.g. laminated or molded on the inlay. A typical RFID inlay is flexible, and, depending on the overlay, the RFID tag can be flexible or rigid. RFID inlays are typically sold in reels or rolls comprising hundreds to thousands of inlays. Generally the RFID tags can be either active or passive depending on whether they include an internal energy source, or they are operated with the electro-magnetic field generated by the RFID reader device.

RFID tags can operate on several frequencies. Four frequency ranges are generally defined as: (1) low frequency (LF); frequencies below 135 kHz, (2) high frequency (HF); frequencies around 13.56 MHz, (3) ultra high frequency (UHF); frequencies between 860 MHz and 960 MHz, and (4) microwave; frequencies around 2.54 GHz. RFID tags can be designed to operate near the reader device, or far from the reader device.

In case tags are designed to work near the reader device, the tags are known as near field tags, and the energy transfer from the reader device to the RFID tag is mostly through the magnetic field generated by the RFID reader. Data transfer from the tag to the reader device in near field case is enabled by inductive coupling, where the RFID tag changes its impedance, and the alternating load is detected by the reader device. Sometimes the communication in the near field is known as near field communication (NFC).

In case the tags are designed to work far away from the reader device, the tags are known as far field tags, and the energy transfer from the reader device to the tag is mainly through the electric field. Part of the RFID tag operates as an antenna, and the RFID device gets its energy from the electric field. In the far field case, data transfer from the tag to the reader device is enabled by field backscattering. In addition to the antenna, the RFID tag may comprise an impedance matching loop to fit the impedance of the RF communication circuit with the antenna.

The theoretical limit between the near field and the far field is proportional to λ/2π, where λ is the wavelength of the electromagnetic radiation generated by the reader device, equaling to c/f, where c is the speed of radiation (i.e. light) and f is the frequency. As a result, the limit between near and far fields for a HF RFID system would be 3.5 m and for an UHF RFID system the limit would be 5 cm. One can also define a transition zone between the near field and the far field.

In the near field tags, the strength of the inductive coupling between the RFID tag and the RFID reader is proportional to the area enclosed by the wiring of the RFID inlay. In the far field tags, the wiring of the RFID inlay performs as an antenna, and the length of the wiring must therefore be proportional to the wavelength λ. Even if these wirings can be made to meander in the inlay, these physical principles determine size limits for the RFID inlays, e.g. the minimum size.

RFID devices and the RF communication devices discussed above are generally energetically essentially passive. Such energetically essentially passive RFID tags are tags that operate while being in the reader field and being able to draw energy from the field. The field may be an electromagnetic field. The energetically essentially passive tags may comprise a capacitor to allow for short operation even when the field is turned off.

In addition to the identification, such RFID tags may be used for measurements. Therefore, in addition to identification, also other types of RF communication may be enabled with RF communication devices. The present invention is related particularly to energetically essentially passive RF transponders and their assemblies. Such energetically essentially passive RF transponders may be RFID tags, or may be able to perform other functions while engaged using an electromagnetic field. The energetically essentially passive RF communication devices may, in addition to drawing energy from the field, store the energy e.g. in to a capacitor. Thus they may operate for a while even without the presence of the field.

The size of such energetically passive RF communication devices is limited from below in principle in at least two ways:
1) the frequency of the RF communication device need the match the specification for the device, and
2) the size of the device must be so large as to be able to draw energy from an electromagnetic field.

How the operating frequency is related to the size of an assembly will be apparent later.

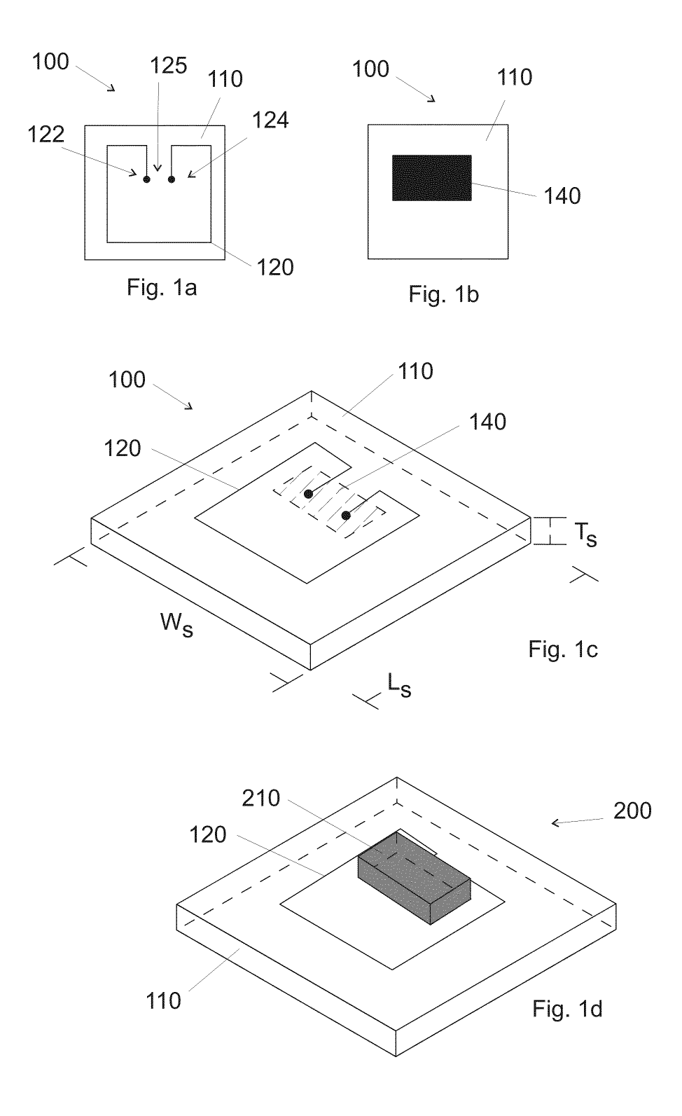

FIGS. 1a-1c show an embodiment of the invention from different viewing angles. FIG. 1a shows an assembly 100 for a radio frequency (RF) communication circuit as seen from top. The assembly 100 comprises an electrically insulating substrate 110 having a first side and a second side. In FIG. 1a, only the first side is shown. The assembly 100 further comprises a first electrically conductive structure 120 arranged on the first side of the substrate 110.

The first electrically conductive structure has the structure of a split loop, wherein the split loop structure comprises a first end 122 and a second end 124. A RF communication circuit is arranged to be attached to the first end 122 and to the second 124. A split 125 is arranged in between the first end 122 and the second end 124. Thus the loop is a split loop. The RF communication circuit is arranged to be attached to a site for the RF communication circuit. The site is at the split, i.e. between the first end 122 and the second end 124. The RF communication circuit is arranged to be attached to its site such that the RF communication circuit closes the split loop. Thereby a closed loop is formed from the split loop and the communication circuit.

A loop, by definition is a structure that starts and ends at the same point. A loop further has a length, i.e. a loop is not a single point. Therefore a loop encircles a central part, and the angle of view of the loop, as viewed from the central part, is the full circle, i.e. 360 degrees. A split loop is splitted by the split 125. Therefore, the angle of view of a split loop is less than the full circle. The ends 122 and 124 of the split loop are located relatively close to each other such that the RF communication circuit is can be attached to both the ends. The linear size of such circuits may be e.g. from 0.1 mm to 5 mm. Thus, the width of the split may be e.g. less than 5 mm. Typically the linear size of an RFID chip is about 0.5 mm.

FIG. 1b shows the assembly 100 for a radio frequency (RF) communication circuit of FIG. 1a as seen from bottom. The assembly 100 comprises a second electrically conductive structure 140 arranged on the second side of the substrate.

The second electrically conductive structure arranged with respect to the first electrically conductive structure in such a manner that the site for the RF communication circuit overlaps the second electrically conductive structure. For example, at least one of the first end 122 and the second end 124 of the split loop 120 may overlap the second electrically conductive structure 140. In FIGS. 1b to 1d the site for the RF communication circuit overlaps the second electrically conductive structure. In FIGS. 1b to 1d both the ends 122 and 124 overlap the second electrically conductive structure 140.

FIG. 1d shows a radio frequency transponder 200 comprising the assembly of FIG. 1c and further comprising the RF communication circuit 210. RF communication circuit 210 is attached to the assembly 100 such that a part of the RF communication circuit 210 is attached to the first end 122 of the split loop and another part of the RF communication circuit 210 is attached to the second end 124 of the split loop, whereby the RF communication circuit 210 and the split loop structure form a closed loop.

The structures are such aligned for the following reason: the operating frequency of such a transponder depends, among other things, on the inductances and the capacitances of the device. In principle the operating frequency f is related to the inductance L and the capacitance C such that the frequency f is proportional to inverse of the square root of (LC), i.e. f is proportional to (LC)^{-1/2}. Therefore, increasing the inductance decreases the frequency. Furthermore, increasing the capacitance decreases the frequency. Inductance is related e.g. to the length of the wirings in the device. Decreasing the length decreases the inductance. When decreasing the size of the device, the wires tend to get shorter. This in effect decreases the inductance and increases the operating frequency. However, the operating frequency of the device is limited by the reader device and by standards. Therefore, in order to compensate for the decreasing inductance, capacitance should be increased.

The capacitance depends e.g. on the capacitance on the RF communication circuit 210 and on the capacitance experienced by the circuit 210 due to the assembly 100. The latter capacitance depends on the capacitance of the joint, by which the RF communication circuit is attached to the assembly 100, and on the internal capacitances of the assembly. In principle, the total capacitance may be written as (1/C)=(1/C_{chip})+(1/C_{chip-assembly}). Here C is the capacitance as defined above, C_{chip} is the internal capacitance of the chip 210 and C_{chip-assembly} is the capacitance experienced by the circuit 210 due to the assembly 100, when the chip 210 is attached to the assembly 100.

It has been noticed that the second electrically conductive structure 140 on the second side of the substrate 110 increases the capacitance C_{chip-assembly} significantly. The chip 210 not only experiences the capacitance of the joint by which the chip 210 is attached on to the first side of the substrate 110, but in addition experiences an additional capacitance in relation to the second electrically conductive structure 140 on the second side of the substrate 110. Therefore, the capacitance of the device increases, as compared to a structure without the second conductive structure 140.

As discussed above, when targeting to a small structure, the decrement in inductance should be taken into account by an increment in the capacitance. Therefore, the assembly 100 comprises the second electrically conductive structure 140 in order to increase the capacitance of the assembly 100 for RF communication circuit.

To increase the capacitance the second electrically conductive structure 140 may overlap at least one of the ends 122 and 124. In order to better characterize overlapping, it is noted that the substrate defines a direction, e.g. a direction perpendicular to the first surface. This direction is referred to as the direction of the substrate thickness. If the substrate is planar, the direction of substrate thickness is the direction from the first side to the second side. The first end 122 overlaps the second conductive structure 140, when a first line, that comprises the first end 122 of the first electrically conductive structure 120, and that is parallel to the direction of the substrate thickness, also comprises a point of the second electrically conductive structure 140. Moreover, the second end 124 overlaps the second conductive structure 140, when a second line, that comprises the second end 124 of the first electrically conductive structure 120, and that is parallel to the direction of the substrate thickness, also comprises a point of the second electrically conductive structure 140. Still further, the site for the RF communication circuit overlaps the second electrically conductive structure, when a third line, that comprises a point of the site for the RF communication (e.g. a point of the split 125), and that is parallel to the direction of the substrate thickness, also comprises a point of the second electrically conductive structure 140. It is noted that a line is a set of points.

It has further been noticed that increasing the capacitance C_{chip-assembly} the operating frequency of the manufactured RF communication devices show less variation. As was discussed, the operating frequency depends e.g. on the capacitance. Furthermore, this capacitance depends on the capacitance of the joint, by which the RF communication circuit is attached to the assembly 100, and on the internal capacitances of the assembly. However, the capacitance of the joint has some variations, since it depends on the joint, e.g. the shape of the joint that joins the chip to the assembly. The shape joint on the other hand depends on the translational and rotational positions of the chip with respect to the assembly. These have some variation due to the manufacturing process. Moreover, the joining pressure may affect these positions. Therefore, the capacitance of the joint has some variation. However, the capacitance C_{chip-assembly} is further affected by the internal capacitances of the assembly. Therefore, the proportional variation becomes much smaller, as the capacitance is increased by the second electrically conductive structure 140.

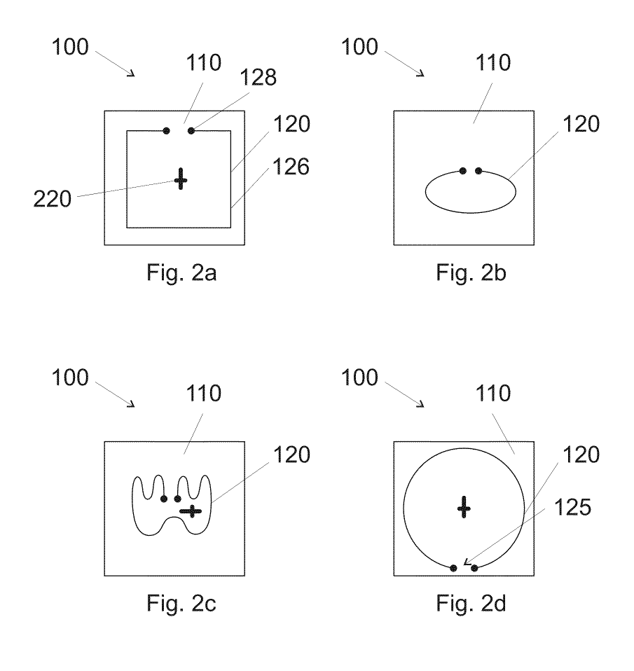

FIGS. 2a-2d show split-loop structures. In FIG. 2a the first conductive structure 120 has the shape of a split square. The first conductive structure 120 comprises an electrically conductive wire 126, and two conductive pads 128. The pads are arranged at the ends of the structure 120. The pads may be used for connecting the chip 210 (FIG. 1d) to the first conductive structure 120. The split square forms the split loop. In addition, a focusing mark 220 is shown. The focusing mark 220 may be used to facilitate locating of the second electrically conductive structure 140 on the second side of the substrate 110, with respect to the first electrically conductive structure 120 on the first side of the substrate 110, to a location such that the second conductive structure increases the capacitance. The focusing mark 220 may be arranged in at least one of the first side of the substrate and the second side of the substrate.

FIG. 2b shows a split loop, wherein the structure is a split ellipse. FIG. 2c shows a split loop, wherein the structure is a split arbitrary loop. FIG. 2d shows a split loop, wherein the structure is a split ring. The ring refers to an essentially circular structure. Thus split ring refers to a structure, wherein the circular ring is broken by the split 125. Even if not explicitly shown with a reference numeral, the split 125 is present in all the split loop structures of FIGS. 2a-2d.

In general, an electromagnetic field does not penetrate a metal sheet as well as it penetrates air. As an energetically passive device may draw its energy from the field, it may be preferable, that the field is not required to penetrate a conductive sheet. As shown in FIGS. 1a-1c, the second electrically conductive structure may therefore have such a shape, that it does not overlap the whole split loop. The second electrically conductive structure 140 does not overlap the whole split loop, when a line that penetrates a central part of the split loop structure, and that is parallel to the direction of the substrate thickness, does not comprise a point of the a point of the second electrically conductive structure. The line that penetrates a central part of the split loop structure is a line that is surrounded by the split loop structure. Moreover, the line that penetrates a central part of the split loop structure is a line that does not comprise a point of the first conductive structure 120. In order to keep the area for field penetration relatively large, preferably at least half (50%) of the central area of the split loop on the first side of the substrate 110 is not overlapped by the second electrically conductive structure 140 on the second side of the substrate 110. The term overlapping is understood in the sense described above for a single point.

The split ring structure (FIG. 2d) is a preferred shape for near field tags, since in near field tags the area of the loop should be large. A large area means that more magnetic energy can be extracted from the field with the loop. A circular shape (i.e. a split ring) has a large area with respect to the linear size (i.e. diameter) of the split loop.

It has also been noticed that as the first conductive structure 120 and the second conductive structure 140 are separated by the insulating substrate 110, a capacitance is formed between the first 120 and second 140 structures. Also this capacitance has the tendency of reducing the frequency, as discussed above. Therefore, preferably a large portion of the area of the first electrically conductive structure 120 overlaps the second electrically conductive structure 140. Moreover, to ease the field penetration, the second structure 140 should have an open area corresponding to the central area of the first split loop structure 120. An open area and relatively large overlap between the structures may be achieved, when the second structure 140 is either a loop or a split loop. The split loop structure is preferred, as it prevents the formation of an electric short circuit in the second electrically conductive structure. Therefore, preferably also the second electrically conductive structure is a split loop structure.

Thus, the second electrically conductive structure 140 may also have the shape of a split loop. As the second electrically conductive structure 140 and the first electrically conductive structure 120 are arranged on different surfaces of the substrate 110, the first and the second structures are capacitively coupled to each other. Furthermore, when also the second electrically conductive structure 140 is a split loop structure, the second electrically conductive structure 140 may be used to guide a magnetic field penetrating the first and the second split loop structures. In particular also the second electrically conductive structure 140 may be used to extract energy from an electromagnetic field.

As a large portion of the area of the first electrically conductive structure 120 may overlap the second electrically conductive structure 140, e.g. at least 50%, at least 66%, or at least 85% of the area of the first electrically conductive structure 120 may overlap the second electrically conductive structure 140. The second electrically conductive structure may also be a split loop structure.

Even more preferably the first electrically conductive structure 120 essentially completely overlaps the second electrically conductive structure 140, wherein the second electrically conductive structure 140 is also a split loop structure. The term “essentially completely overlaps” refers to the situation, where the structures overlap except for the splits.

More specifically, the substrate 110 defines a direction, e.g. a direction perpendicular to the first surface. This direction is referred to as the direction of the substrate thickness. The substrate may be planar. In the planar case, the direction of the substrate thickness is a direction from the first side to the second side. The second electrically conductive structure 140 may be arranged in relation to the first electrically conductive structure 120 such that each line that comprises a point of the first electrically conductive structure 120 and that is parallel to the direction of the thickness of the substrate either

(i) also comprises a point of the second electrically conductive structure 140, or
(ii) penetrates the split 125 of the split loop structure of the second electrically conductive structure 140.

In the case where a large portion a large portion of the area of the first electrically conductive structure 120 overlaps the second electrically conductive structure 140, overlapping is understood in the same sense as discussed above for the case of essentially complete overlapping.

FIG. 2e1 shows a first electrically conductive split ring structure 120. The structure has the first end 122 end the second end 124. The split 125 is arranged in between these ends. The split 125 is also a site for a RF communication circuit. In addition, a focusing mark 220 is shown. FIG. 2e2 shows a corresponding second electrically conductive split ring structure 140 with the split 145. FIG. 2e3 shows the first structure of FIG. 2e1 and the second structure of FIG. 2e2 when aligned with respect to each other. It is understood, that a substrate 110 is located between these structures (cf. FIG. 1c), even is the substrate is not shown in the figures. When the structures 120 and 140 are aligned, first of all, the site for the RF communication circuit on the first side of the substrate (i.e. the split 125) is being overlapped with the second electrically conductive structure 140 on the other side of the substrate. This is shown in the FIG. 2e3 with the reference numerals 125 and 140, particularly by the location for the numeral 140. Furthermore, when the structures are aligned, the first electrically conductive structure 120 essentially completely overlaps the second electrically conductive structure 140, and the second electrically conductive structure 140 is also a split loop structure. In some other embodiments, due to manufacturing tolerances, due to different pad configurations (pad 128, cf. FIG. 2a), or for other reasons, it is also possible that the overlap is not essentially complete. In this case a large portion of the area of the first electrically conductive structure 120 may overlap the second electrically conductive structure 140. FIGS. 2e3, 2f3, and 2g3 show the overlap, however for the case of essentially complete overlap.

FIGS. 2f1-2f3 show conductive split loop structures. The reference numerals were explained in context of FIG. 2e1-2e3. The overlapping of different areas of the split loops were also discussed in context of FIGS. 2e1-2e3. In contrast to FIGS. 2e1-2e3, FIGS. 2f1-2f3 show conductive split loop structures, wherein the shape of the split loop is a rounded square.

FIGS. 2g1-2g3 show further conductive split loop structures. The reference numerals were explained in context of FIG. 2e1-2e3. The overlapping of different areas of the split loops were also discussed in context of FIGS. 2e1-2e3. In contrast to FIGS. 2e1-2e3, FIGS. 2g1-2g3 show conductive split loop structures, wherein the shape of the split loop is a rounded triangle.

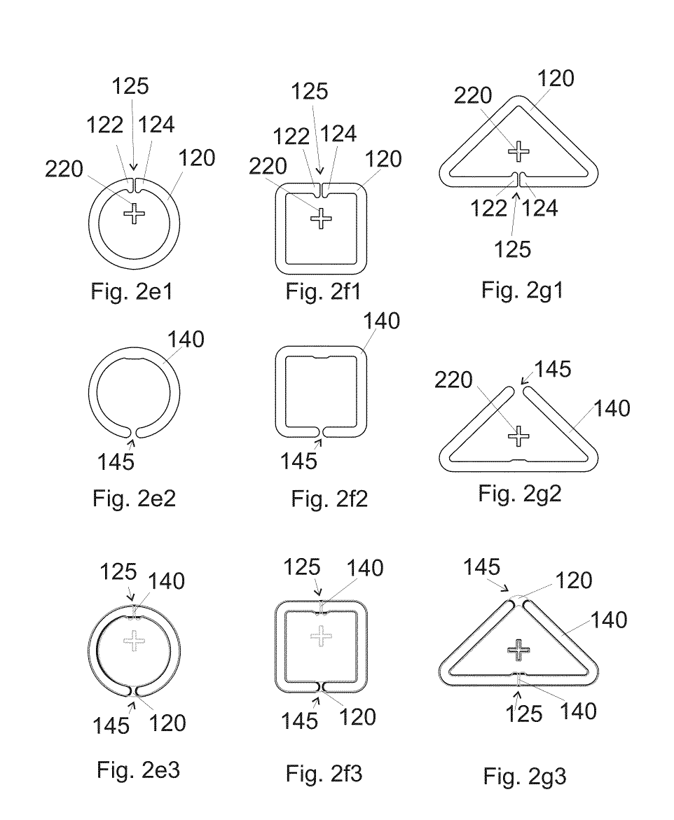

FIGS. 3a, 3b, and 3c show such an embodiment, wherein both the split loops 120, 140 are also split rings. FIG. 3a shows the structure from a top view, wherein only the first electrically conductive structure 120 is shown. FIG. 3b shows the structure from a bottom view, wherein only the second electrically conductive structure 140 is shown. FIG. 3c shows the structure in a perspective view, wherein both the electrically conductive structures 120 and 140 are shown. The first structure 120 is shown in grey colour to distinct it from the second structure 140.

As depicted in FIGS. 3a to 3c, the width of the second structure 140 may be greater than the width of the first structure 120. Alternatively, the widths may be equal. The names of the structures 120 and 140 are interchangeable. The first structure 120 may be selected to describe the thinner (or otherwise smaller) of the structures 120, 140.

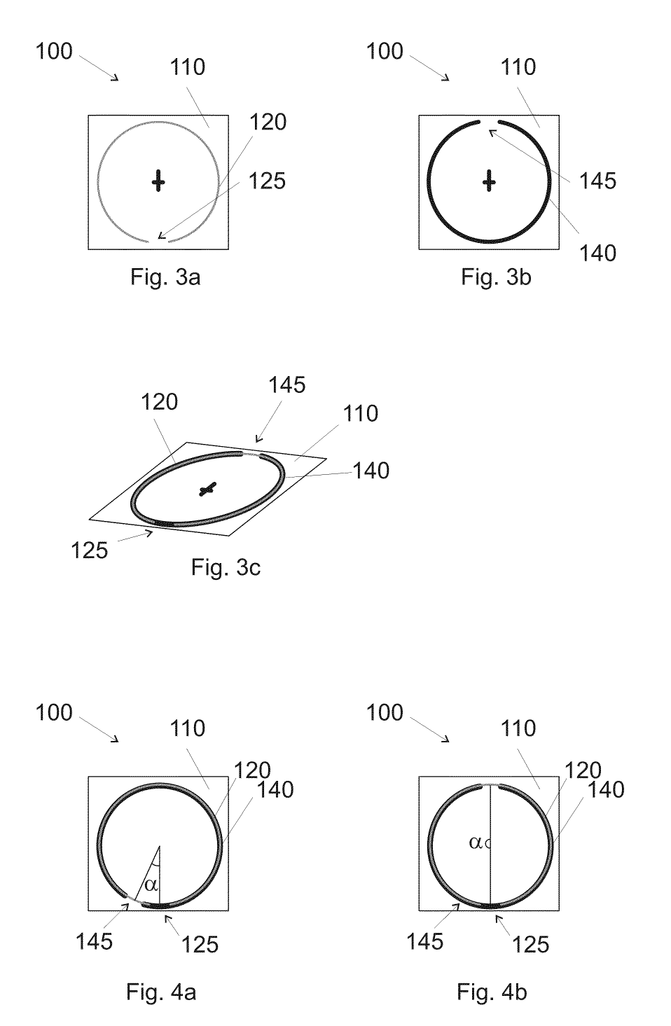

Referring to FIGS. 4a and 4b, the split 125 of the first split loop structure and the split 145 of the second split loop structure are arranged, with respect to each other, in an angle. The situation is symmetric, and therefore, the angle may be measured in a clockwise or an anticlockwise direction. Thus the minimum value in principle could be zero degrees, and the maximum value 180 degrees. If the angle is very small, i.e. the splits are aligned, the increase in the capacitance, as discussed above, is lost. Therefore the angle may be e.g. at least 15 degrees.

FIG. 4a shows the structure in a top view, however showing both electrically conductive structures 120 and 140, wherein the angle is small. In FIG. 4a, the angle is depicted with α, and the angle has the value of 25 degrees. In FIG. 4b, the angle is depicted with α, and the angle has the value of 180 degrees. Preferably the angle is large, e.g. more than 170 degrees, and even more preferably about 180 degrees.

In a preferred embodiment, both the first electrically conductive structure 120 and the second electrically conductive structure 140 have the shape of a split ring, and the inner and outer diameters of the split rings are equal, i.e. the shape of the second electrically conductive structure is similar to the shape of the first electrically conductive structure. The electromagnetic properties of the structure may be tuned with the angle α.

The substrate 110 may comprise polymer material. The polymer material may be e.g. polyethylene terephthalate (PET). PET has good electric properties for the purpose, and can be manufactured in relatively thin sheets. As known from the theory of plate capacitors, a thin substrate may increase the capacitance more than a thick substrate. The thickness of the substrate, Ts (FIG. 1c), may be from 5 μm to 100 μm, or preferably in the range from 20 μm to 40 μm, to increase the capacitance. In addition or alternatively, the substrate 110 may comprise fibrous material such as paper. In addition or alternatively, the substrate may comprise ferromagnetic material to improve the magnetic coupling of the RF communication device and the reader device. In addition or alternatively, the substrate may comprise dielectric material, such a ceramics with a high permeability, to further increase the capacitance and thus decreasing the size or frequency.

Thickness, Ts, width, Ws, and length, Ls, of the substrate 110 are shown in FIG. 1c. The width, Ws, of the substrate depends on the use, and may be e.g. from 3 mm to 20 cm. The length, Ls, of the substrate depends on the use, and may be e.g. from 3 mm to 20 cm. In an embodiment, the outer diameter of the split ring is 7 mm, and the width and the length of the substrate are slightly more, about 8 mm.

At least one of the first electrically conductive structure 120 and the second electrically conductive structure may comprise metal. At least one of the structures 120, 140 may comprise at least one of the following metals: copper, aluminium, silver, and gold. The thickness of the conductive structure may be from 1 to 50 μm, preferably from 5 to 10 μm.

Copper and aluminium are relatively cheap conductor materials, and can be easily etched. In an embodiment, the electrically conductive structures are formed by etching. Therefore, in some embodiments one of copper and aluminium are preferred for the conductor materials.

In an embodiment one or several of the following features may be present:
the first electrically conductive structure 120 comprises aluminium,
the second electrically conductive structure 140 comprises aluminium,
the thickness of at least one conductive structure is 9 μm,
the substrate 110 comprises polyethylene terephthalate (PET),
the thickness of the substrate is 38 μm,
the width of electrical wiring forming the split loop structure of the first electrical structure is less than 1.5 mm, preferably about 0.75 mm, and
the outer diameter of the split loop is less than 15 mm, preferably less than 10 mm, e.g. about 7 mm.

The diameter of a non-circular split loop may be regarded as the smallest of the dimensions from one boundary of the split loop to an opposite boundary of the split loop.

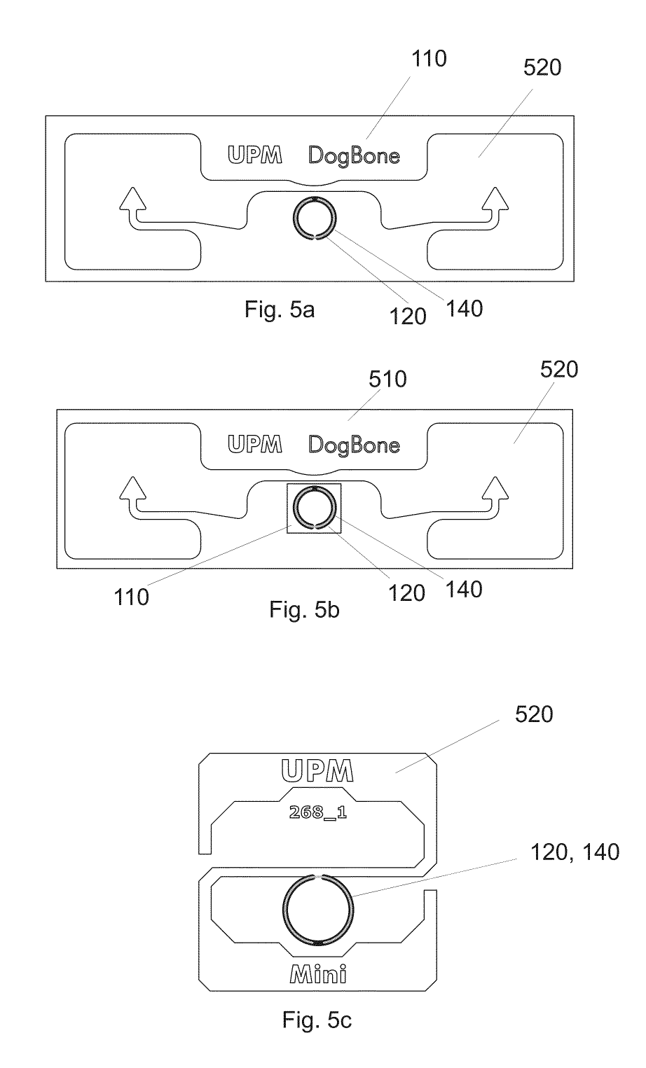

The assembly of two split loop structures as described above may also be used in connection with an antenna structure. FIG. 5a shows an assembly comprising the first 120 and second 140 electrically conductive structures as discussed above. The embodiment of FIG. 5a further comprises an antenna structure 520. The split loop structures 120 and 140 are located a distance apart from the antenna structure 520. Therefore, at least one of the split loop structures 120, 140 is capacitively or inductively coupled to the antenna structure 520. In this way, a radio frequency antenna for boosting radio frequency transmission is formed. In FIG. 5a, the antenna structure 520 is arranged on the same substrate 110 as the split loop structures 120, 140.

Referring to FIG. 5b, the antenna structure 520 may also be arranged onto another substrate 510. The loop structures 120 and 140 and the substrate 110 in between the structures may be attached to the other substrate 510.

Referring to FIG. 5c, one of the loop structures 120, 140 may be galvanically connected to the antenna structure 520. In a galvanic contact there is no distance between the loop structure and the antenna structure. Thus the electromagnetic field in the loop 120 or 140 may propagate galvanically, i.e. through the conductive material, to the antenna structure 520.

The dual-layer structure of the split loops, as discussed above, may diminish the size of the frequency matching loop of an antenna structure. Also, if more space is available for an antenna, the meandering antenna structure may be made somewhat straighter, which improves the properties of the antenna. The antenna structure 520 may be e.g. a dipole antenna.

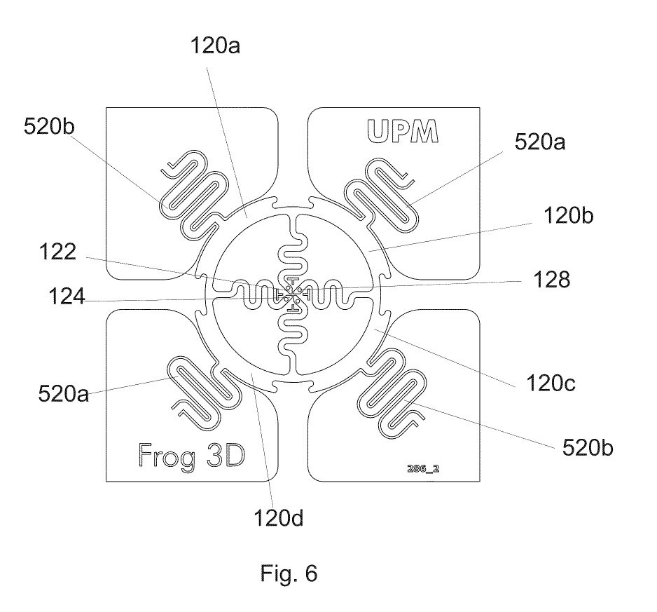

FIG. 6 shows another structure, wherein two dipole antennas 520a and 520b are arranged perpendicularly to each other in a plane. The structure is capable of operating in various rotational positions with respect to a reader device. A first electrically conductive structure is shown in the figure with the reference numerals 120a, 120b, 120c, and 120d. Each of these parts of the first electrically conductive structure forms a split loop. Two ends (122, 124) of the split loop 120a structure are also shown. In addition, the ends comprise pads 128 for attaching a RF communication circuit to the assembly. As is clear from the figure, the first electrically conductive structure comprises also other ends; four ends in total. The structure is designed for a RF communication circuit comprising four terminals. Each end of the first electrically conductive structure corresponds to a terminal of the RF communication circuit. The second electrically conductive structure 140 is not shown in FIG. 6. It is understood, that the second electrically conductive structure 140 is arranged on the second side of the substrate at least to the central part, in order to increase the capacitance as discussed above. The second electrically conductive structure 140 may further comprise at least one area forming at least one split loop. The area or areas may be aligned with at least one of the split loop structures 120a, 120b, 120c, and 120d.

Assemblies with dipole antennas may be used e.g. in far field communication, wherein the energy is extracted from electromagnetic field, mostly from the electric part of the field.

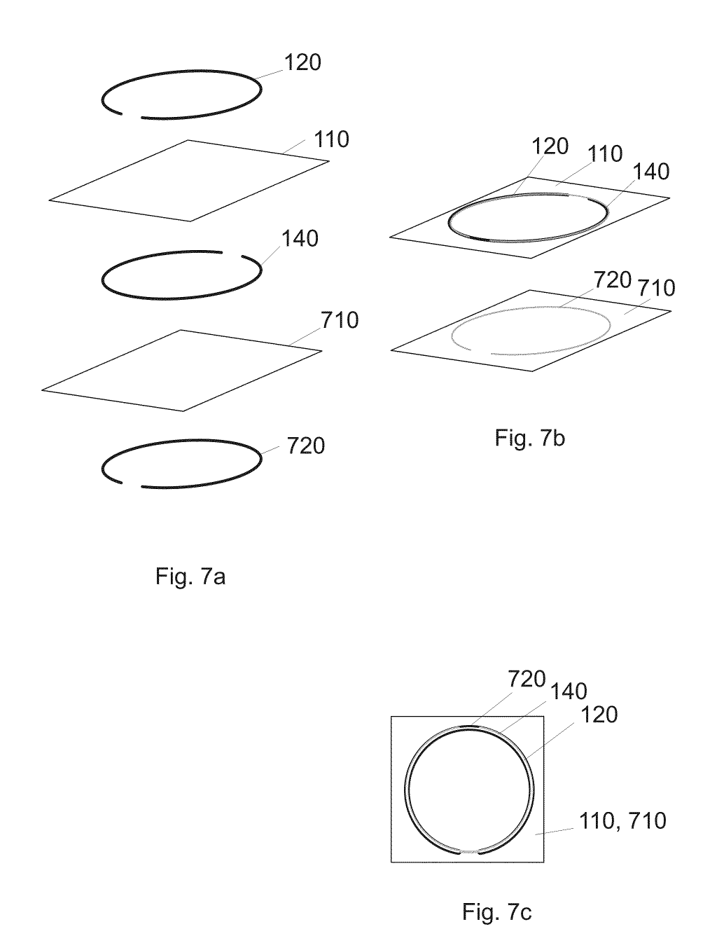

In near field communication, wherein the energy is extracted from electromagnetic field, mainly from the magnetic part, the magnetic coupling between the reader device and the RF communication device may be further enhanced by increasing the number of overlapping split loops. FIG. 7a shows, in an exploded perspective view, layers of an RF assembly. In addition to the part that have been described earlier, the assembly of FIG. 7a comprises
a second substrate 710 comprising a first side and a second side, and
a third electrically conductive structure 720 arranged on a first side of the second 710 substrate, wherein
the first electrically conductive structure 120 or the second electrically conductive structure 140 is arranged on the second side of the second substrate 710,
the third electrically conductive structure 720 at least partly overlaps the first or the second electrically conductive structure 120, 140, and
the third electrically conductive structure 720 has the shape of a split loop.

This assembly further guides a magnetic field penetrating the split loop structures, and enhances to magnetic coupling between the RF communication assembly and the reader device. In FIG. 7a the split loop structures have the shape of a (circular) split ring structures.

Referring to FIG. 7b, the structure with three split loops may be manufactured e.g. by manufacturing a first assembly comprising the first substrate 110 with the first and second electrically conductive layers 120 and 140; manufacturing a second assembly comprising the second substrate 710 and the third electrically conductive layer 720; and attaching the second assembly to the first assembly. FIG. 7c shows an assembly with three the co-centric overlapping split ring structures.

Referring to FIG. 1d, an RF communication circuit 210 may be attached to the assembly of any of the FIGS. 1a-1c, 2-6, and 7c. In addition, the RF communication circuit 210 may be attached to a partial assembly (e.g. the first or the second assembly discussed in the context of FIG. 7b). The assembly with the RF communication circuit forms a radio frequency transponder 200. In the transponder, the RF communication circuit 210 is attached to the assembly 100 such that a part of the RF communication circuit 210 is attached to the first end of the split loop and another part of the RF communication circuit is attached to the second end of the split loop, whereby the RF communication circuit and the split loop structure form a closed loop.

The RF communication circuit 210 may be attached to the assembly 100 by using known join techniques such as adhesive joining or solder joining. Adhesive joining may be done using electrically conductive or non-conductive adhesives. Conductive adhesives may be isotropically conductive or anisotropically conductive. Adhesives may be supplied in the form of film or paste. Anisotropic adhesives are particularly suitable for attaching small RF communication circuits 210 to the assembly 100. Solder joining may also be applied.

The radio frequency transponder 200 may be arranged to extract its operating power from an electromagnetic field using the closed loop formed by the RF communication circuit 210 and a split loop, whereby the radio frequency transponder may be energetically essentially passive.

The transponder may be attached to an item. The item may be e.g. a commercial item. The commercial item may be available for sale in a store. The item may be stored in a warehouse and/or tracked for inventory purposes. The item may be a vessel arranged to contain samples, whereby the RF transponder may be used to identify the sample.

A particularly attractive application is one, where several small objects are to be identified from a close distance. The objects may need to be identified all at substantially the same time or in sequence. As the objects are small, a large coil structure is not a feasible solution. The objects may be arranged in a row or in a matrix. In near field communication, the area within a loop affects the magnetic coupling between a reader and the RF communication device. As some of the embodiments have multiple (two or three) split loops, the magnetic coupling is good even if the size of a single loop is relatively small. Moreover, because of the overlapping structures and increased capacitance, a reasonably operating frequency is obtained with small structures.

1. An assembly for a radio frequency (RF) communication circuit, comprising
an electrically insulating substrate having a first side and a second side,
a first electrically conductive structure arranged on the first side of the substrate, wherein
the first electrically conductive structure has the structure of a split loop, wherein the split loop structure comprises a first end and a second end, wherein the RF communication circuit is arranged to be attached to a site for the RF communication circuit between the first end and the second end such that the RF communication circuit closes the split loop, and
a second electrically conductive structure arranged on the second side of the substrate, wherein
the second electrically conductive structure is arranged with respect to the first electrically conductive structure in such a manner that the site for the RF communication circuit overlaps the second electrically conductive structure;
in order to increase the capacitance of the assembly for the RF communication circuit, whereby
the assembly is configured to operate with an RFID tag operating on an ultra high frequency (UHF) between 860 MHz and 960 MHz.

2. The assembly of claim 1, wherein
the substrate is planar, whereby the substrate defines a direction from the first side to the second side, and
the second electrically conductive structure is arranged in relation to the first electrically conductive structure such that
a line that penetrates a central part of the split loop structure, and that is parallel to the direction of the thickness of the substrate, does not comprise a point of the second electrically conductive structure.

3. The assembly of claim 1, wherein
the first electrically conductive structure has the shape of a circular split ring.

4. The assembly of claim 1, wherein
the second electrically conductive structure has the structure of a split loop;
to guide a magnetic field penetrating the first and the second split loop structures.

5. The assembly of the claim 4, wherein
at least 50% of the of the area of the first electrically conductive structure overlaps the second electrically conductive structure.

6. The assembly of the claim 5, wherein
the substrate is planar, whereby the substrate defines a direction from the first side to the second side, and
the second electrically conductive structure is arranged in relation to the first electrically conductive structure such that
each line that comprises a point of the first electrically conductive structure and that is parallel to the direction of the thickness of the substrate either
(i) also comprises a point of the second electrically conductive structure, or
(ii) penetrates the split of the split loop structure of the second electrically conductive structure.

7. The assembly of claim 4, wherein
the split of the first split loop structure and the split of the second split loop structure are arranged, with respect to each other, in an angle, wherein
the angle is at least 15 degrees.

8. The assembly of the claim 7, wherein
the angle is at least 170 degrees.

9. The assembly of claim 1, wherein
the shape of the second electrically conductive structure is a circular split ring structure.

10. The assembly of the claim 9, wherein
the shape of the second electrically conductive structure is similar to the shape of the first electrically conductive structure.

11. The assembly of claim 1, wherein
the substrate comprises a polymer, such as polyethylene terephthalate (PET).

12. The assembly of claim 1, wherein
the thickness of the substrate is from 5 μm to 100 μm, preferably from 20 μm to 40 μm.

13. (canceled)

14. The assembly of claim 1, wherein
the width of electrical wiring forming the split loop structure of the first electrical structure is less than 1.5 mm, preferably about 0.75 mm.

15. The assembly of claim 1, wherein
the diameter of the split loop of first electrical structure is less than 10 mm.

16. The assembly of claim 1, wherein
the assembly comprises at least one antenna structure galvanically, capacitively, or inductively coupled to at least one of the first electrically conductive structure and the second electrically conductive structure;
to form a radio frequency antenna for boosting radio frequency transmission.

17. The assembly of claim 16, wherein
the antenna structure is a dipole antenna structure.

18. The assembly of claim 1, comprising
a second substrate and
a third electrically conductive structure arranged on a first side of the second substrate, wherein
the first or the second electrically conductive structure is arranged on the second side of the second substrate,
the third electrically conductive structure at least partly overlaps the first or the second electrically conductive structure, and
the third electrically conductive structure has the shape of a split loop;
in order to further to guide a magnetic field penetrating the loop structures.

19. The assembly of claim 1, comprising
a focusing mark on at least one of the first and the second side of the substrate;
in order to facilitate locating the second electrically conductive structure with respect to the first electrically conductive structure.

20. A radio frequency transponder, comprising
a radio frequency (RF) communication circuit, and
the assembly for the RF communication circuit according to claim 1, wherein
the RF communication circuit is attached to the assembly such that a part of the RF communication circuit is attached to the first end of the split loop and another part of the RF communication circuit is attached to the second end of the split loop, whereby the RF communication circuit and the split loop structure form a closed loop.

21. (canceled)

22. The radio frequency transponder of claim 21, wherein
the RF communication circuit is arranged to extract its operating power from the electromagnetic field using the closed loop.

23. The radio frequency transponder of claim 20, wherein
the RF communication circuit is a radio frequency identification (RFID) circuit, whereby the radio frequency transponder is a RFID transponder.

24. (canceled)
